(19) United States
(12) Patent Application Publication
(10) Pub. No.: US 2007/0200655 A1
(43) Pub. Date: Aug. 30, 2007

(54) Electromagnetic actuator performing quick response

(75) Inventors: Fumiaki Murakami, Okazaki-city (JP); Shigeru Nonoyama, Nishikamo-gun (JP); Naoki Mitsumata, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/633,435

(22) Filed: Dec. 5, 2006

(30) Foreign Application Priority Data
Feb. 27, 2006 (JP) 2006-049795

(51) Int. Cl. H01F 7/08

(52) U.S. Cl. 335/281

(57) ABSTRACT

An electromagnetic actuator includes a cylindrical coil, a stator core disposed in the cylindrical coil, a plate attached to one axial end of the stator core and an armature positioned to face the other axial end of the stator core. Upon energizing the coil, the armature is attracted to the stator core against a biasing force of a spring disposed in an inner space of the stator core. A depressed portion is formed on the plate and/or the stator core to suppress a magnetic flux passing therethrough and to reduce an amount of leakage flux. The magnetic flux generated by the coil is effectively used to drive the armature, and thereby a response time of the actuator is shortened. In other words, the armature is quickly driven upon energizing the coil.

### CROSS-REFERENCE TO RELATED APPLICATION

This application is based upon and claims benefit of priority of Japanese Patent Application No. 2006-49795 filed on Feb. 27, 2006, the content of which is incorporated herein by reference.

### BACKGROUND OF THE INVENTION

1. Field of the Invention

The present invention relates to an electromagnetic actuator having an armature driven by a magnetic force.

2. Description of Related Art

In a fuel injection system having an accumulator for accumulating pressurized fuel, the pressurized fuel in the accumulator is released by a depressurizing valve and returned to a fuel tank when an internal combustion engine, such as a diesel engine, is decelerating. The pressure of the pressurized fuel in the accumulator is decreased to a predetermined level in this manner. The depressurizing valve includes a coil generating a magnetic force for attracting a biased armature to thereby open a passage for releasing the pressurized fuel. An example of this type of electromagnetic actuator is disclosed in JP-A-2001-182638.

The pressure in the accumulator has to be quickly decreased by the electromagnetic actuator. In other words, the electromagnetic actuator has to quickly respond to a deceleration signal. It is generally required to improve a response of an electromagnetic actuator used in systems other than the injection system.

### SUMMARY OF THE INVENTION

The present invention has been made in view of the above-mentioned problem, and an object of the present invention is to provide an improved electromagnetic actuator that quickly responds to a signal supplied thereto.

The electromagnetic actuator of the present invention includes a cylindrical coil for generating magnetic flux upon energization, a cylindrical stator core disposed in an inner space of the cylindrical coil, a plate facing one axial end of the coil and an armature facing the other axial end of the coil. Upon energizing the coil, the armature is attracted to the stator core against a biasing force of a spring disposed in an inner space of the stator core, and thereby a valve passage is open by a valve rod connected to the armature.

The plate includes a depressed portion for suppressing an amount of magnetic flux passing therethrough. The magnetic flux is effectively utilized to attract the armature toward the stator core by reducing a leakage flux. Therefore, the armature is quickly attracted to the stator core upon energization of the coil. In other words, a response time of the actuator is improved (shortened). The electromagnetic actuator is advantageously used as an actuator for a pressure relief valve in a common rail-type injection system, for example.

The depressed portion may be formed on one axial end of the stator core facing the plate, or it may be formed on both of the stator core and the plate. The depressed portion may be formed as a through-hole passing through an entire thickness of the plate. The plate and the stator core may be integrally formed, and the depressed portion may be formed at a center portion of the plate. It is preferable to make a diameter of the depressed portion in a range from 0.6·di2 to 0.9·Di2, where di2 is an inner diameter of the inner space of the stator core and the Di2 is an outer diameter of the stator core. By setting the diameter of the depressed portion in this range, the response time is surely improved. Preferably, a depth of the depressed portion is made larger than an air gap between the armature and the stator core, which is formed when the armature is attracted to the stator core, to surely improve the response time.

According to the present invention, a depressed portion is formed on the stator core and/or the plate for reducing a leakage flux and for effectively utilizing the flux. The response time of the electromagnetic actuator is improved. Other objects and features of the present invention will become more readily apparent from a better understanding of the preferred embodiments described below with reference to the following drawings.

### BRIEF DESCRIPTION OF THE DRAWINGS

FIG. 1 is a block diagram showing an entire structure of a fuel injection system having an accumulator for accumulating pressurized fuel;

FIG. 2 is a cross-sectional view showing a depressurizing valve used in the injection system as a first embodiment of the present invention;

FIG. 3 is a cross-sectional view showing components of the depressurizing valve before being assembled to an accumulator;

FIG. 4 is a cross-sectional view showing the depressurizing valve connected to the accumulator;

FIG. 5 is a graph showing a response time of the depressurizing valve in relation to a diameter of a depressed portion formed in a plate used in a coil unit; and

FIG. 6 is a cross-sectional view showing a depressurizing valve used in the injection system as a second embodiment of the present invention.

### DETAILED DESCRIPTION OF THE PREFERRED EMBODIMENTS

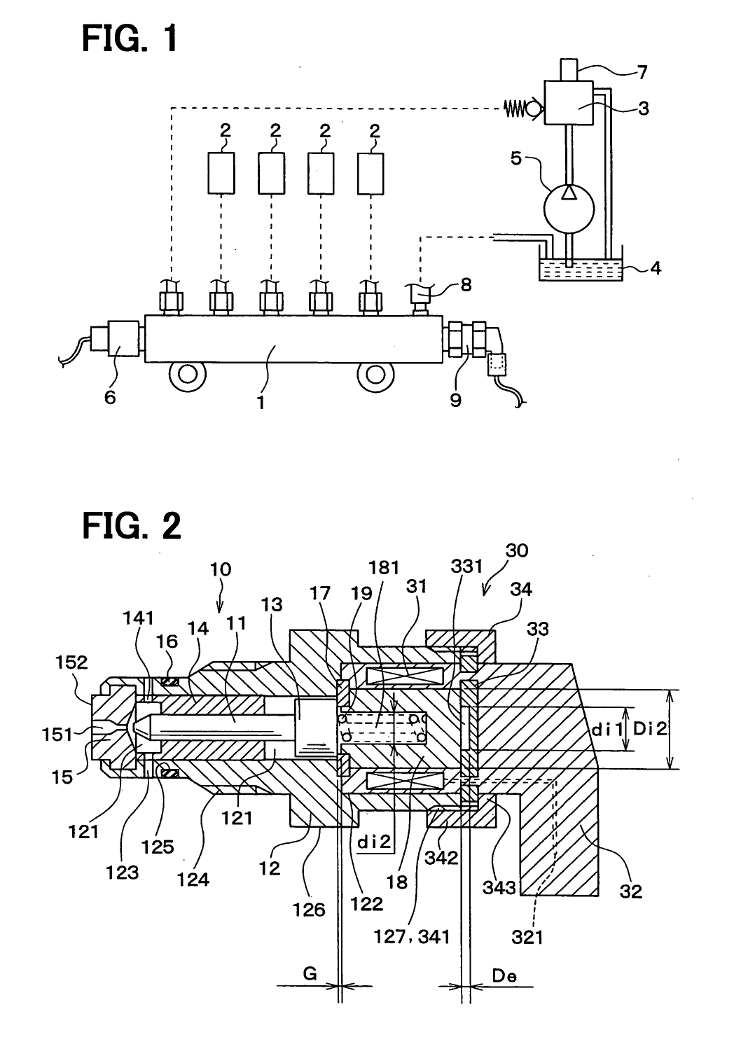

A first embodiment of the present invention will be described with reference to FIGS. 1-5. A fuel injection system shown in FIG. 1 includes an accumulator 1 in which high pressure fuel is accumulated, fuel injectors 2 installed to each cylinder of a diesel engine and a fuel pump 3 for supplying pressurized fuel to the accumulator 1. Fuel is supplied to each cylinder from each fuel injector which is electronically controlled by an electronic control unit (referred to as an ECU).

The ECU is a known microcomputer including CPU, ROM, RAM and other components. The fuel injection system is controlled according to a program stored in the ECU and based on various signals fed to the ECU. The signals fed to the ECU from sensors include a rotational speed of the engine and a pressed-down amount of an acceleration pedal.

Fuel in a fuel tank 4 is pumped up by a feed pump 5 and supplied to a fuel pump 3 that pressurizes fuel to a high pressure. The fuel pump 3 is a known high pressure pump which is able to deliver variable amounts of fuel. An amount of fuel supplied to the accumulator 1 is controlled by a control valve 7 which is in turn controlled by the ECU. The fuel pressure in the accumulator 1 is detected by a pressure sensor 6. An amount of fuel is controlled by the control valve 7, so that the fuel pressure in the accumulator becomes to a level predetermined according to respective operating conditions of the engine, such as engine speeds and engine loads.

One end of the accumulator 1 is connected to the fuel tank 4 through a leak pipe 8 which is opened or closed by a depressurizing valve 9. The fuel in the accumulator 1 is returned to the fuel tank 4 by opening the leak pipe 8. The depressurizing valve 9 is controlled by the ECU according to operating conditions of the engine. For instance, the fuel pressure in the accumulator 1 is decreased to a target level when the engine is decelerating.

With reference to FIGS. 2-4, the depressurizing valve 9 will be described in detail. The depressurizing valve 9 is composed of a valve unit 10 and a coil unit 30. The valve unit 10 includes a cylindrical valve body 12 made of a magnetic metal. In the valve body 12, a first space 121 and a second space 122 are formed continuously in the axial direction. A valve rod 11 connected to an armature 13 is disposed in the first space 121, a cylindrical coil 31 of the coil unit 30 is disposed in the second space 122. The valve rod 11 is slidably supported in a guide pipe 14 held in the first space 121 of the valve body 12. The armature 13 is made of a magnetic metal and connected to the valve rod 11 by press-fitting or welding.

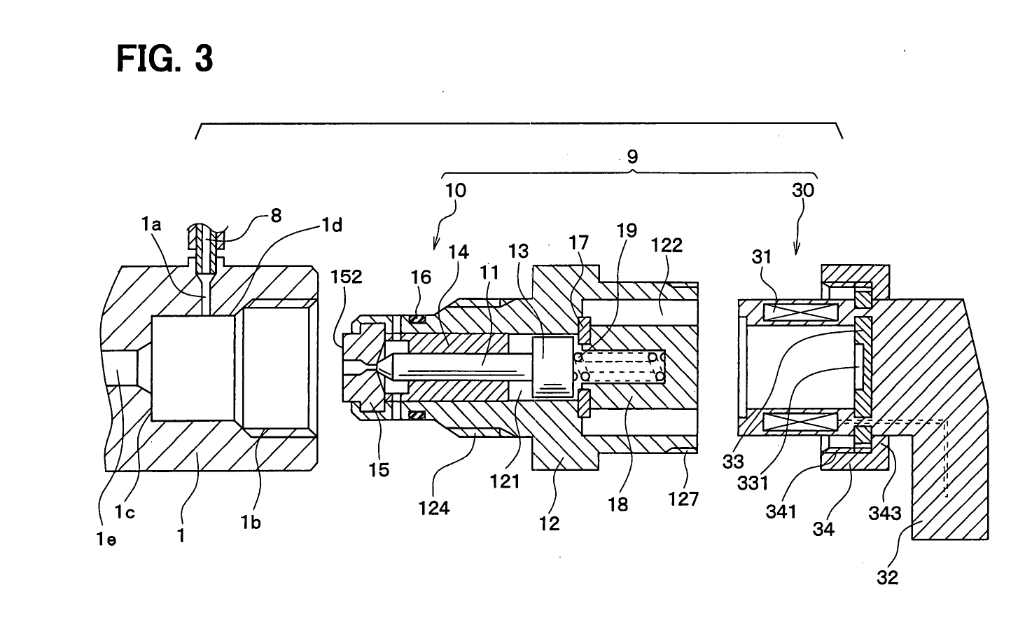

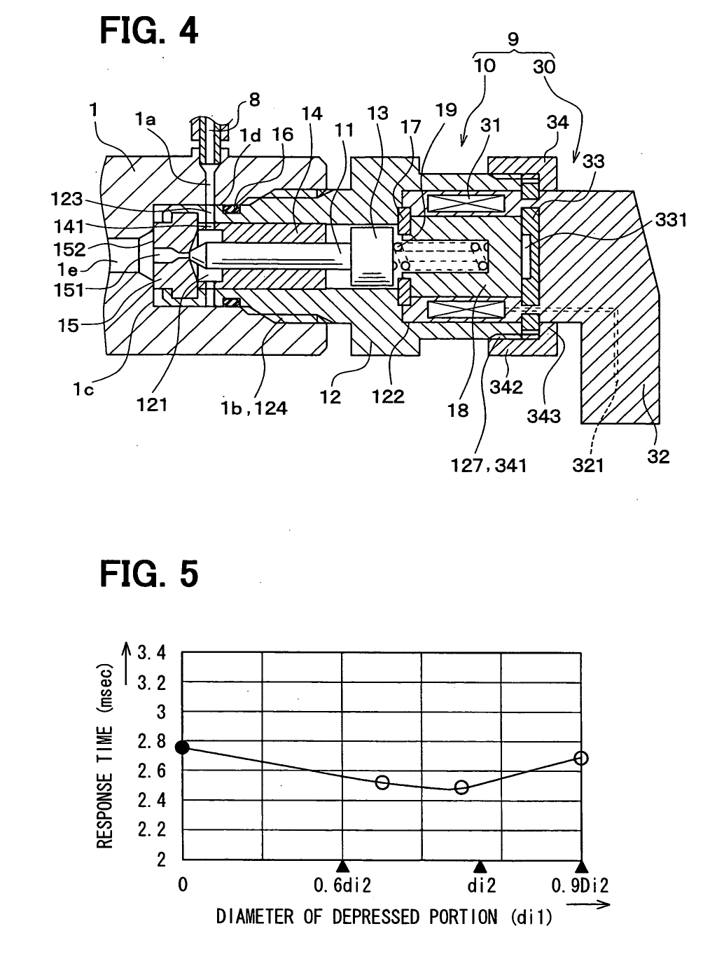

A valve seat 15 is fixed to an axial end of the valve body 12 by press-fitting or staking. The first space 121 communicates with an inner space of the accumulator 1 through a through-hole 151 formed in the valve seat 15. The first space 121 is also connected to a through-hole 1a formed in the accumulator 1 (shown in FIG. 4) via a through-hole 141 formed in the guide pipe 14 and a through-hole 123 formed in the valve body 12. The through-hole 1a is connected to the leak pipe 8. On an outer surface of the valve body 12, a first male screw 124 to be connected to a female screw 1b (shown in FIG. 3) of the accumulator 1, a circular groove 125 in which a sealing member 16 is disposed, a hexagonal portion 126 and a second male screw 127 connected to a retaining nut 34 are formed.

A circular connecting member 17 made of a non-magnetic metal is disposed at a boundary between the first space 121 and the second space 122. The connecting member 17 is hermetically connected to the valve body 12 and the stator core 18 by welding or brazing, and thereby the first space 121 is hermetically separated from the second space 122. The stator core 18 is made of a magnetic material and shaped in a cylindrical form with one end closed. The stator core has an inner space 181 for containing a spring 19 for biasing the armature 13 toward the left side of FIG. 2 (in a direction to close the through-hole 151).

The coil unit 30 is composed of a cylindrical coil 31, a connector 32, a plate 33 and a retaining nut 34. The coil 31 and the plate 33 are integrally molded with molding resin, forming the connector 32 with the molded resin. An outer periphery of the plate 33 is exposed outside of the molded resin, and a terminal molded in the connector 32 is electrically connected to the coil 31. The stator core 18 is disposed in a cylindrical space formed in the cylindrical coil 31. The plate 33 is made of a magnetic material and shaped in a round disc. The plate 33 is positioned to face one axial end of the coil 31 and to contact one axial end of the stator core 18 and the valve body 12. Thus, the plate 33 forms a magnetic circuit together with the valve body 12, the armature 13 and the stator core 18. At the center of the plate 33, a depressed portion 331 is formed facing the one axial end of the stator core 18. The depressed portion 331 suppresses an amount of magnetic flux passing from the stator core 18 to the plate 33.

The coil unit 30 is connected to the valve body 12 by the retaining nut 34. The retaining nut 34 has a cylindrical portion 342 in which a female screw 341 is formed and a flange 343. The female screw 341 is screwed to a second male screw 127 formed on the valve body 12, and thereby the coil unit 30 is connected to the valve unit 10. The outer periphery of the plate 33 is surrounded and held by the retaining nut 34.

Referring to FIG. 3, a process of connecting the depressurizing valve 9 to the accumulator 1 will be explained. First, the coil unit 30 is connected to the valve unit 10 by screwing the second male screw 127 of the valve body 12 to the female screw 341 of the retaining nut 34. Then, the valve unit 10 to which the coil unit 30 is assembled is connected to the accumulator 1 by screwing the first male screw 124 of the valve body 12 to a female screw 1b of the accumulator 1. The top surface 152 of the valve body 12 firmly abuts a bottom surface 1c of the accumulator 1, thereby firmly sealing a connecting portion between two surfaces by an axial force generated by screwing. The sealing member 16 disposed in the circular groove 125 is pressed against an inner surface 1d of the accumulator 1, thereby sealing the connecting portion between the inner surface 1d and the outer periphery of the valve body 12.

Then, a position of the connector 32 relative to the accumulator 1 is adjusted by loosing the retaining nut 34. Finally, the retaining nut 34 is again firmly fastened. Thus, the connecting process is completed. It is possible to change a sequence of the installing process described above. Namely, the valve unit 10 may be first connected to the accumulator 1, and then the coil unit 30 may be coupled to the valve body 12.

Operation of the depressurizing valve 9 described above will be explained. Normally, the coil 31 is not energized, and the valve rod 11 closes the through-hole 151 of the valve seat 15 by a biasing force of the spring 19. Thus, the leak pipe 8 is closed. When an acceleration pedal is released to decelerate the engine, the coil 31 is energized under control of the ECU. The armature 13 connected to the valve rod 11 is attracted to the stator core 18 against the biasing force of the spring 19, and thereby the valve rod 11 is lifted from the valve seat 15, opening the through-hole 151. Pressurized fuel in the accumulator 1 is returned to the fuel tank 4 through the through-hole 151 of the valve seat 15, the through-hole 141 of the guide pipe 14, the through-hole 123 of the valve body 12, the through-hole 1a of the accumulator 1 and the leak pipe 8. Thus, the fuel pressure in the accumulator 1 is decreased to a target level.

Now, advantages attained by forming the depressed portion 331 in the plate 33 will be explained. An amount of magnetic flux flowing from the stator core 18 to the plate 33 is suppressed by the depressed portion 331, and an amount of leakage flux is reduced. Therefore, the magnetic flux effectively flows through the magnetic circuit, and thereby the armature 13 is quickly attracted to the stator core 18 upon energizing the coil 31. In other words, a response time for opening the depressurizing valve is shortened. The depth De (shown in FIG. 2) of the depressed portion 331 is made larger than an air gap G (shown in FIG. 2) between the armature 13 and the stator core 18, which is formed when the armature 13 is attracted to the stator core 18. In this manner, the response time is further securely improved.

FIG. 5 shows the response time of the depressurizing valve versus a diameter di1 (shown in FIG. 2) of the depressed portion 331. In obtaining the test results shown in FIG. 5, the depth De of the depressed portion is set to 0.5 mm, and the diameter di2 (shown in FIG. 2) of the inner space 181 is made approximately a half of the outer diameter Di2 (shown in FIG. 2) of the stator core 18. In FIG. 5, a response time of a prototype having no depressed portion (di1=0) is shown with a black circle, and response times of the present embodiment having the depressed portion 331 are shown with white circles.

As seen in FIG. 5, the response time is improved (shortened) by 0.25 m second at maximum, compared with the prototype having no depressed portion. It is also seen that the response time improvement becomes low when the diameter di1 of the depressed portion 331 is much larger than the diameter di2 of the inner space 181. This is because an area of the plate 33 facing the stator core 18 becomes too narrow by making the diameter di1 too large. This results in decrease in an amount of the magnetic flux flowing between the armature core 18 and the plate 33 and decrease in the attracting force. The test results shown in FIG. 5 indicate that the response time is surely improved when the diameter di1 is set in a range from 0.6·di2 to 0.9·Di2.

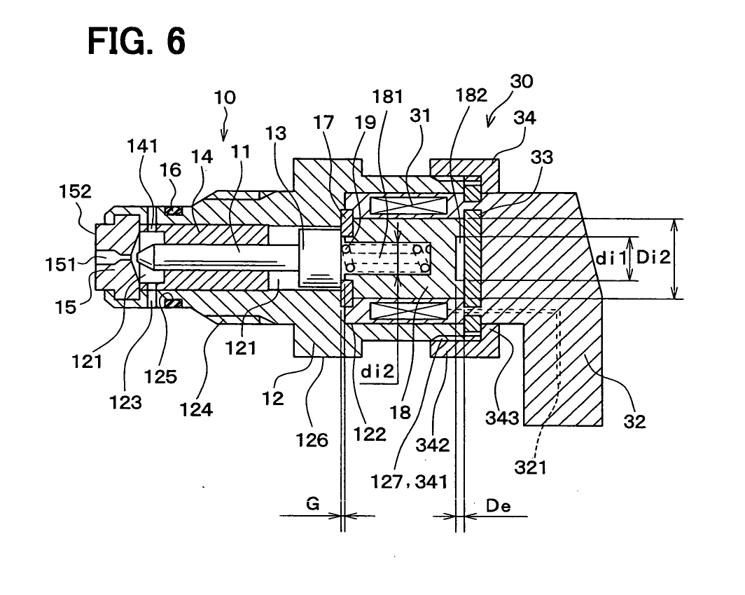

A second embodiment of the present invention will be described with reference to FIG. 6. In this embodiment, the depressed portion 182 is formed in the stator core 18 to face the plate 33. Other structures and functions are the same as those of the first embodiment. A magnetic flux flow from the stator core 18 to the plate 33 is suppressed by the depressed portion 182. Therefore, the magnetic flux is effectively used in the magnetic circuit, reducing an amount of leakage of the magnetic flux. Accordingly, the response time of the depressurizing valve is shortened in the same manner as in the first embodiment.

The present invention is not limited to the embodiments described above, but it may be variously modified. For example, the depressed portions may be formed in both of the plate 33 and the stator core 18 to face each other. Two depressed portions 331 may be formed on both surfaces of the plate 33 to become symmetric in the thickness direction of the plate 33. The depressed portion 331 may be made through-hole passing through an entire thickness of the plate 33. Though the stator core 18 and the plate 33 are separately formed in the foregoing embodiments, they may be integrally formed. In this case, the integral piece is formed so that a cylindrical portion functions as the stator core 18 and a flange portion functions as the plate 33, and a depressed portion is made on the outer surface of flange portion.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An electromagnetic actuator comprising:
a cylindrical coil generating a magnetic field by supplying electric current thereto;
a stator core disposed in a cylindrical coil;
a plate positioned at one axial end of the cylindrical coil and the stator core; and
an armature positioned at another axial end of the cylindrical coil and the stator core, the armature forming a magnetic circuit together with the stator core and the plate, the armature being attracted toward the stator core upon generation of the magnetic field, wherein:
the stator core includes a depressed portion for suppressing an amount of magnetic flux flowing therethrough, the depressed portion being formed on one axial end of the stator core facing the plate.

2. An electromagnetic actuator comprising:
a cylindrical coil generating a magnetic field by supplying electric current thereto;
a stator core disposed in a cylindrical coil;
a plate positioned at one axial end of the cylindrical coil and the stator core; and
an armature positioned at another axial end of the cylindrical coil and the stator core, the armature forming a magnetic circuit together with the stator core and the plate, the armature being attracted toward the stator core upon generation of the magnetic field, wherein:
the plate includes a depressed portion for suppressing an amount of magnetic flux flowing therethrough, the depressed portion being formed on one surface of the plate facing the stator core.

3. The electromagnetic actuator as in claim 2, wherein:
the armature core includes another depressed portion for suppressing an amount of magnetic flux flowing therethrough, the other depressed portion being formed on one axial end of the stator core facing the plate.

4. The electromagnetic actuator as in claim 2, wherein:
the plate further includes another depressed portion for suppressing an amount of magnetic flux flowing therethrough, the another depressed portion being formed on the other surface of the plate symmetrically to the depressed portion formed on the one surface.

5. The electromagnetic actuator as in claim 2, wherein:
the depressed portion is formed in the plate to pass through an entire thickness of the plate.

6. The electromagnetic actuator as in claim 1, wherein:
a depth of the depressed portion is larger than an air gap between the armature and the stator core which is formed when the armature is attracted to the stator core.

7. The electromagnetic actuator as in claim 2, wherein:
a depth of the depressed portion is larger than an air gap between the armature and the stator core which is formed when the armature is attracted to the stator core.

8. The electromagnetic actuator as in claim 1, wherein:
the armature is biased in a direction away from the stator core by a biasing spring disposed in an inner space formed in the stator core; and
a diameter of the depressed portion is in a range from 0.6·di2 to 0.9·Di2, where di2 is an inner diameter of the inner space formed in the stator core and Di2 is an outer diameter of the stator core.

9. The electromagnetic actuator as in claim 2, wherein:
the armature is biased in a direction away from the stator core by a biasing spring disposed in an inner space formed in the stator core; and
a diameter of the depressed portion is in a range from 0.6·di2 to 0.9·Di2, where di2 is an inner diameter of the inner space formed in the stator core and Di2 is an outer diameter of the stator core.

10. An electromagnetic actuator comprising:
a cylindrical coil generating a magnetic field by supplying electric current thereto;
a stator core having a cylindrical portion and a flange connected to one axial end of the cylindrical portion, the flange having a diameter larger than that of the cylindrical portion, the cylindrical portion being disposed in the cylindrical coil, the flange being positioned to face one axial end of the cylindrical coil; and
an armature positioned at another axial end of the cylindrical coil and the stator core, the armature forming a magnetic circuit together with the stator core, the armature being attracted toward the stator core upon generation of the magnetic field, wherein:
the flange includes a depressed portion for suppressing an amount of magnetic flux flowing therethrough, the depressed portion being formed at a center portion of the flange.
